(19) United States
(12) Patent Application Publication
(10) Pub. No.: US 2009/0105984 A1
(43) Pub. Date: Apr. 23, 2009

(54) Methods and Apparatus for Dynamic Data Transformation for Visualization

(76) Inventors: Zhen Wen, Chappaqua, NY (US); Michelle X. Zhou, Briarcliff Manor, NY (US)

Correspondence Address: RYAN, MASON & LEWIS, LLP, 90 FOREST AVENUE, LOCUST VALLEY, NY, 11560, US

(21) Appl. No.: 11/875,399

(22) Filed: Oct. 19, 2007

(51) Int. Cl. G06F 17/30; G06F 15/00

(52) U.S. Cl. 702/127; 707/102; 707/E17.009

(57) ABSTRACT

Data transformation techniques are disclosed for use in such data visualization systems. For example, a method for dynamically deriving data transformations for optimized visualization based on data characteristics and given visualization type comprises the steps of obtaining raw data to be visualized and a visualization type to be used, and dynamically generating a list of data transformation operations that transform the raw input data to produce an optimized visualization for the given visualization type.

### FIELD OF THE INVENTION

The present invention relates to data visualization systems and, more particularly, to data transformation techniques for use in such data visualization systems.

### BACKGROUND OF THE INVENTION

Data or information visualization is known to be an area of computer graphics that is concerned with the presentation of potentially large quantities of data (such as laboratory, simulation or abstract data) to aid cognition, hypotheses building, and reasoning. Data transformation is a critical step in data visualization.

Researchers have developed a number of data transformation techniques to ensure the creation of effective visualizations. To better visualize categorical data, Ma & Hellerstein have developed a clustering approach to ordering nominal data, see S. Ma and J. Hellerstein, “Ordering Categorical Data to Improve Visualization,” InfoVis'99, pp. 15-18, 1999. More recently, data abstraction such as sampling has been used to prepare large-scale data for better visualization, see Q. Cui, M. Ward, E. Rundensteiner, and J. Yang, “Measuring Data Abstraction Quality in Multiresolution Visualization,” IEEE Transactions on Visualization and Computer Graphics, 12(5):709-716, 2006. While this existing work proposes specific data transformation techniques, none of the work addresses how to dynamically choose proper data transformations for better visualization.

Measurement of visualization quality is also an important part of data visualization. Most of such works fall into two categories: assessing visualization quality via empirical studies and evaluating visual quality using computational metrics. For example, statistics-based metrics have been used to measure the quality of histograms and scatter plots, see J. Seo and B. Shneiderman, “A Rank-by-Feature Framework for Interactive Exploration of Multidimensional Data,” Information Visualization, 2005. Image-based metrics have also been developed to assess the quality of jigsaw maps and pixel bar charts or to measure display clutter. Again, however, none of this visualization quality modeling work addresses how to dynamically choose proper data transformations for better visualization.

Visual data mining uses data visualization, see D. Keim, “Information Visualization and Visual Data Mining, “IEEE Transactions on Visualizations and Computer Graphics, 7(1):100-107, 2002. However, visual data mining aims at helping users to manage the mining process through interactive visualization, and not at automated design of visualization and selection of data transformations to ensure the quality of the generated visualization.

### SUMMARY OF THE INVENTION

Principles of the invention provide for data transformation techniques for use in such data visualization systems.

For example, in one aspect of the invention, a method for dynamically deriving data transformations for optimized visualization based on data characteristics and given visualization type comprises the steps of obtaining raw data to be visualized and a visualization type to be used, and dynamically generating a list of data transformation operations that transform the raw input data to produce an optimized visualization for the given visualization type.

In accordance with illustrative embodiments of the invention:

The step of generating a list of data transformation operations may further comprise modeling the data transformation operations uniformly using one or more feature-based representations.

The step of generating a list of data transformation operations may further comprise the step of estimating visualization quality using one or more data characteristics.

The step of estimating visualization quality using one or more data characteristics may further comprise the step of modeling visual quality using one or more feature-based desirability metrics.

The step of modeling visual quality using feature-based desirability metrics may further comprise the step of one of the feature-based metrics measuring a visual legibility value.

The step of one of the feature-based metrics measuring a visual legibility value may further comprise the step of measuring a data complexity value.

The step of one of the feature-based metrics measuring a visual legibility value may further comprise the step of measuring a data density value.

The step of measuring a data density value may further comprise the step of measuring a data cleanness value.

The step of a measuring a data density value may further comprise the step of measuring data volume.

The step of a measuring a data density value may further comprise the step of measuring data variance.

The step of modeling visual quality using one or more feature-based desirability metrics may further comprise the step of one of the feature-based metrics measuring a visual pattern recognizability value.

The step of one of the feature-based metrics measuring a visual pattern recognizability value may further comprise the step of measuring a data uniformity value.

The step of one of the feature-based metrics measuring a visual pattern recognizability value may further comprise the step of a measuring data association value.

The step of modeling visual quality using one or more feature-based desirability metrics may further comprise the step of one of the feature-based metrics measuring a visual fidelity value.

The step of modeling visual quality using one or more feature-based desirability metrics may further comprise the step of one of the feature-based metrics measuring a visual continuity value.

The step of one of the feature-based metrics measuring a visual continuity value may further comprise the step of measuring a data stability value.

The step of one of the feature-based metrics measuring a visual continuity value may further comprise the step of using user intentions.

The step of dynamically generating a list of data transformation operations may further comprise the step of estimating a data transformation cost.

The step of dynamically generating a list of data transformation operations may further comprise the step of performing an optimization operation such that one or more desirability metrics are maximized and a transformation cost is limited for one or more data transformation operations.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts visualizations generated by a visual dialog system in response to user queries in two applications, according to an embodiment of the invention.

FIG. 2 illustrates a visual dialog system, according to an embodiment of the invention.

FIG. 3 visualizes correlation among three data dimensions, according to an embodiment of the invention.

FIG. 4 illustrates dimension ordering so that users can easily perceive different visual clusters, according to an embodiment of the invention.

FIG. 5 illustrates data properties and data operators, according to an embodiment of the invention.

FIG. 6 illustrates dimension ordering so that users can easily perceive correlation, according to an embodiment of the invention.

FIG. 7 illustrates pseudo-code of a data transformation determination algorithm, according to an embodiment of the invention.

FIG. 8 illustrates a computer system wherein techniques for dynamically determining data transformations in accordance with a visual dialog system may be implemented, according to an embodiment of the invention.

### DETAILED DESCRIPTION OF PREFERRED EMBODIMENTS

The present invention will be illustrated below in the context of a visual dialog system executing illustrative visualization applications, i.e., real estate and trade management. However, it is to be understood that the present invention is not limited to any such applications. Rather, the invention is more generally applicable to any applications in which it would be desirable to improve data transformation techniques used to provide one or more visualizations in accordance with such applications. It is to be understood that the term “visualization,” as used herein, generally refers to a visual representation of a given set of data presented to a user on a display screen.

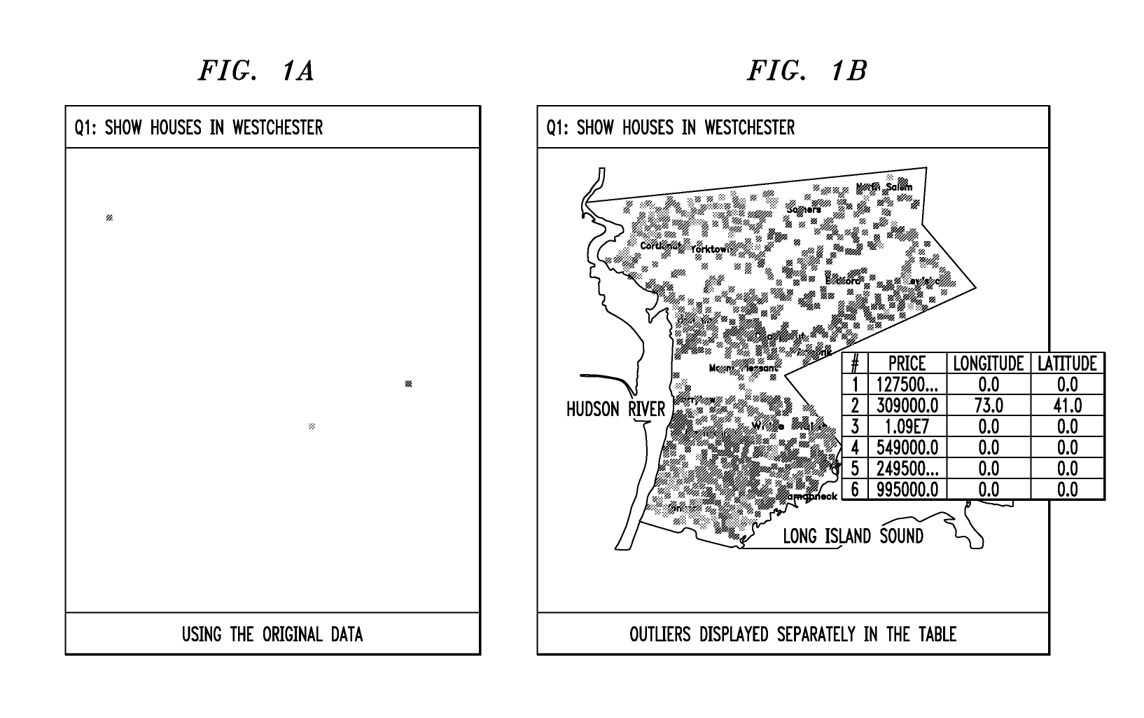

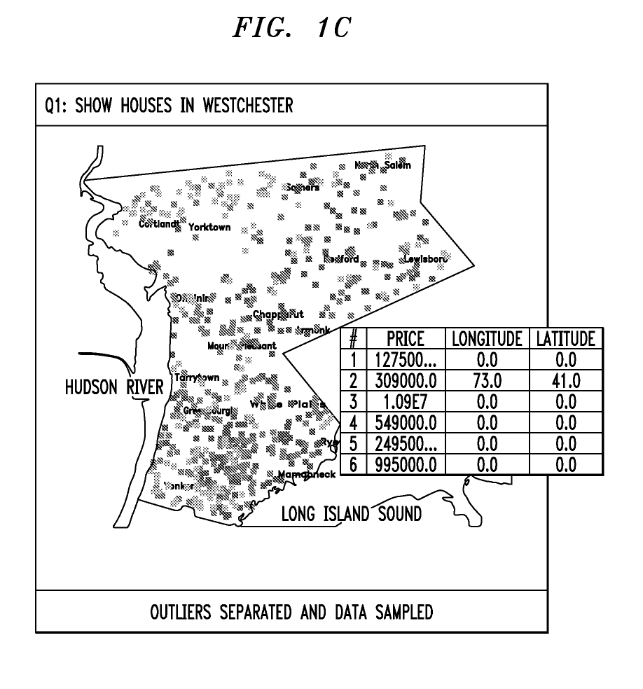

Interactive visual dialog systems aid users in investigating large and complex data sets. To create visualization that is tailored to a user's context including dynamically retrieved data, the generation of visualization is automated. A visual dialog system creates a visualization in three steps. The steps will be discussed in the context of the illustrative set of visualizations in FIG. 1. FIG. 1 depicts visualizations generated by a visual dialog system in response to user queries in two applications. FIG. 1(c) shows a set of requested houses in a real estate application, while FIG. 1(f) shows the port (X axis) and shipment (Y-axis) correlation in a trade management application. It is assumed that FIGS. 1(a), 1(b), 1(d) and 1(e) were created prior to proper data transformations.

First, the system determines the type of the visualization. For example, to respond to Q1 in FIG. 1, a visual dialog system chooses to visualize the requested houses on a map. Second, the visual dialog system transforms the given data to better suit the chosen type of visualization. To produce FIG. 1(c), the visual dialog system first extracts the outliers (i.e., houses with no or wrong locations) and then sub-samples the data to reduce visual clutter. Third, the visual dialog system uses the transformed data to instantiate a visualization. In this invention, the focus is on data transformation, the process that prepares the given data for better visualization.

Prior to visualization, data transformation is often necessary for several reasons. First, raw data may need to be filtered or sampled to better tailor the visualization to users' interests or to reduce visual clutter. Second, raw data may be noisy and data cleaning may be needed to ensure the effectiveness of a visualization. FIG. 1(a) is supposed to be a map-based visualization but completely unrecognizable due to missing/wrong locations of several houses. In contrast, FIG. 1(c) better fulfills the visualization goal as the noisy data were extracted first and then displayed separately.

Third, raw data may contain largely varied values and need to be normalized to ensure the quality of a visualization. FIG. 1(d) is difficult to view, as a large value at one port dwarfs the values at other ports. In comparison, FIG. 1(e) is more legible as it presents the normalized values. Moreover, raw data may be inherently complex, which may require proper transformations for effective visualization. For example, high dimensional data may be divided to produce a series of simpler visualizations for easy comprehension.

Unlike most existing visualization systems, where data transformations are predetermined by human developers, a visual dialog system must decide its needed transformations at run time. This is because in a visual dialog system, users' interactions dynamically determine both the data to be visualized and the type of visualization to be created. Since it is difficult to predict a user's interaction behavior, it is impractical to plan data transformations for all possible data and their visualizations.

To effectively visualize unanticipated data introduced by highly dynamic user interactions, principles of the present invention model data transformation as an optimization problem. A main objective is to dynamically derive a set of data transformations that can optimize the quality of the intended visualization. As a result, principles of the invention provide many advantages. By way of example:

(1) Principles of the invention provide a general solution to data transformation that can automatically derive a set of desired data transformation operations (e.g., cleaning and scaling) for a wide variety of visualization situations.

(2) Principles of the invention present an extensible, feature-based model to uniformly represent data transformation operations and transformation constraints. This model enables us to easily adapt our work to new situations (e.g., new types of visualization).

### System Overview

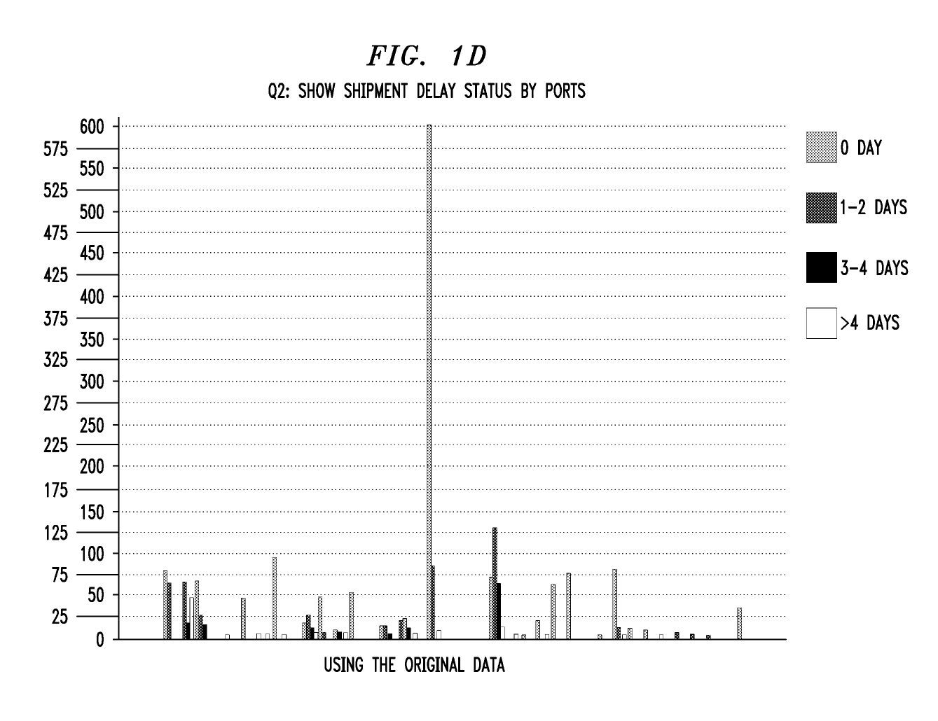

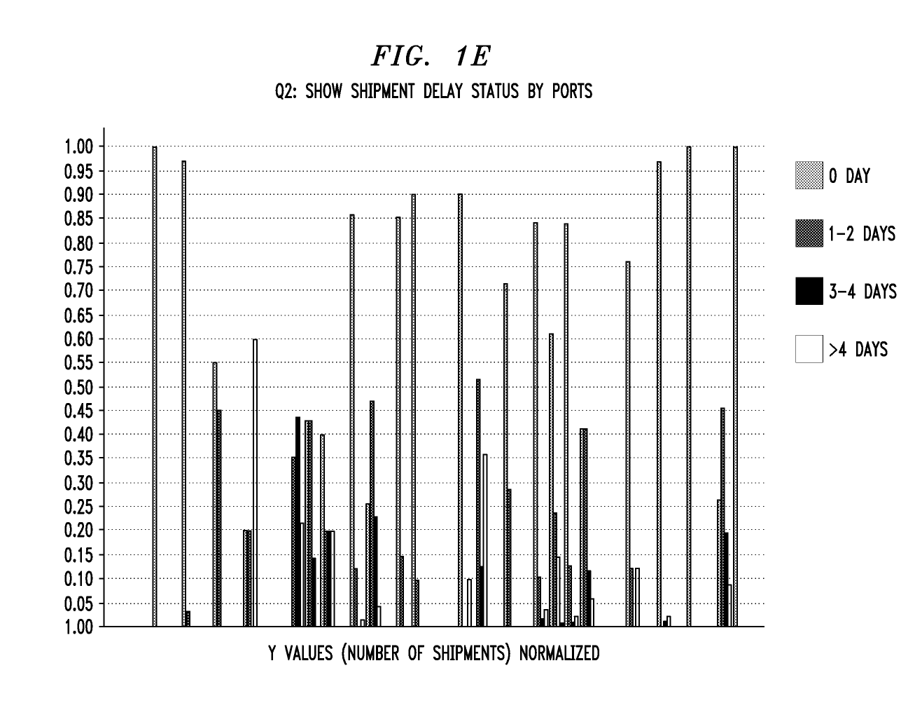

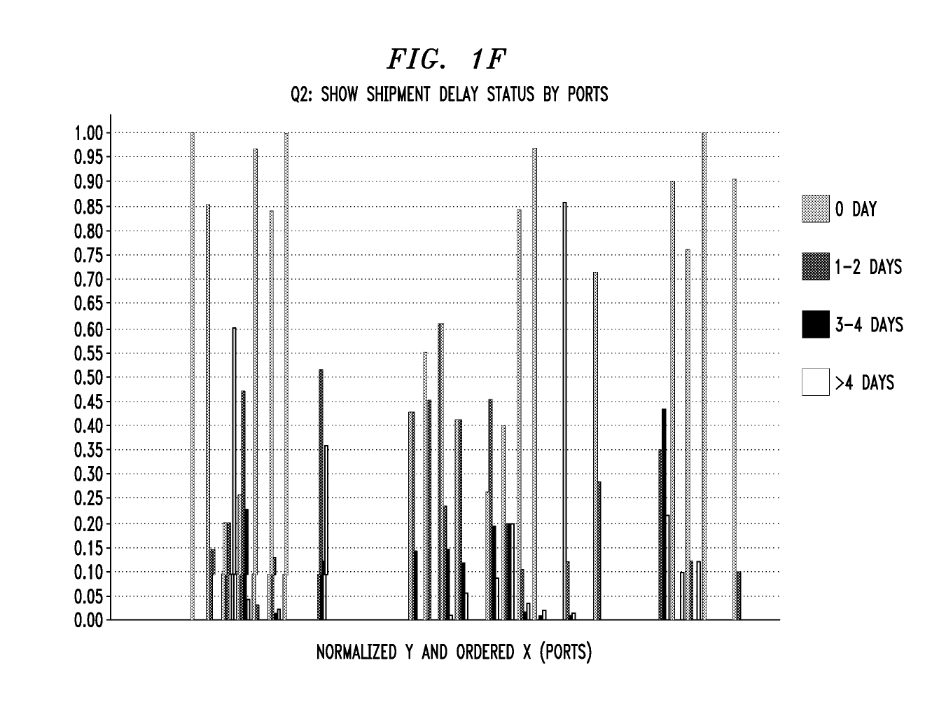

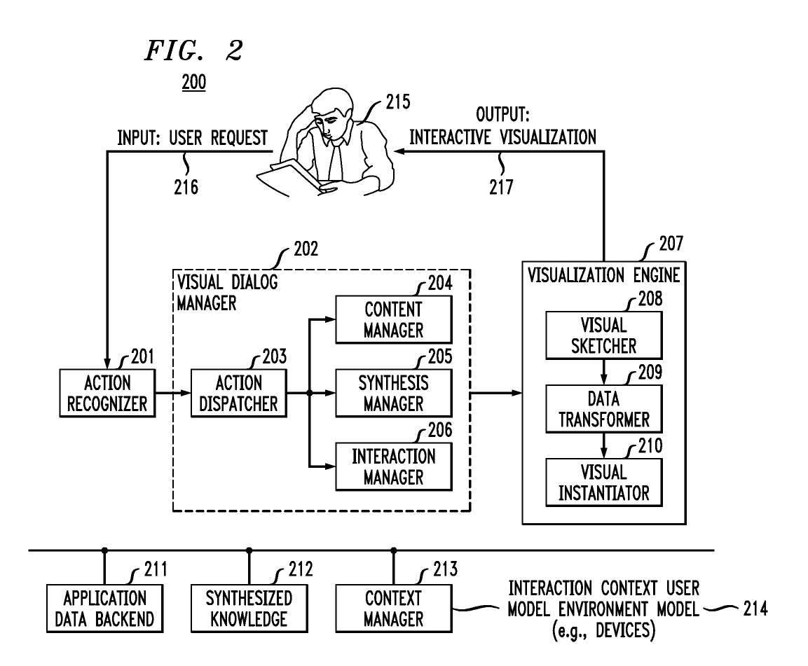

FIG. 2 illustrates a visual dialog system according to an embodiment of the invention. As shown, visual dialog system 200 includes the following functional components: action recognizer 201; visual dialog manager 202 including context manager 204, synthesis manager 205 and interaction manager 206; visualization engine 207 including visual sketcher 208, data transformer 209 and visual instantiator 210; application backend 211 (e.g., databases or text search engines for retrieving application data); synthesized knowledge 212 (e.g., databases holding user-derived knowledge); and context manager 213 which manages user interaction context, including user interests/preferences and environmental settings (e.g., devices capabilities) 214. In general, user 215 inputs one or more requests 216 and, in response, visual dialog system 200 generates and outputs one or more interactive visualizations 217. Further details of these functional components and their interactions will be provided in the descriptions to follow.

First, we provide an overview of the visual dialog system, and then describe its visualization engine. Given a user request, visual dialog system 200 uses action recognizer 201 to identify the type of the request and the parameters. In this illustrative embodiment, it is assumed that the visual dialog system supports three types of user requests: data inquiry (e.g., querying for a set of houses), knowledge synthesis (e.g., summarizing a market trend), and visual manipulation (e.g., highlighting data interests). Each type of request is associated with a set of parameters. For example, a data inquiry has data constraint parameters. The recognized request is then sent to action dispatcher 203. Based on its type, the request is routed to a specific action manager. Content manager 204 handles data inquiry requests by retrieving relevant information. Synthesis manager 205 supports knowledge synthesis by dynamically maintaining a body of user-derived knowledge (e.g., uncovered trend). Interaction manager 206 responds to various user visual manipulations, such as user highlighting. Based on the output of the action managers, visualization engine 207 produces an interactive visualization.

Given a data set, visualization engine 207 automatically creates visualization 217 in three steps. First, visual sketcher 208 determines the type of visualization. Based on the chosen type of visualization, data transformer 209 dynamically derives proper data transformations (e.g., outlier extraction and sampling) to ensure the construction of an effective visualization. Finally, visual instantiator 210 uses the transformed data to create the actual visualization. Principles of the invention focus on the data transformer.

### Example Scenarios

Data characteristics directly impact visualization design. In this section, we use a set of examples to show how different data properties affect the quality of visualization, such as visual legibility and visual fidelity. Accordingly, we describe how proper data transformations can help to improve the visualization quality.

First, data quality, such as data cleanness and data variance, directly impacts visualization quality. For example, noisy data like missing or erroneous data may render the target visualization illegible (FIG. 1(a)). To create a legible display, a visual dialog system according to an embodiment of the invention extracts the outliers and displays them separately (FIG. 1(c)). Likewise, largely varied data values may also render a visualization illegible (FIG. 1(d)). To improve the legibility, a visual dialog system according to an embodiment of the invention normalizes the values before visualizing them (FIG. 1(f)).

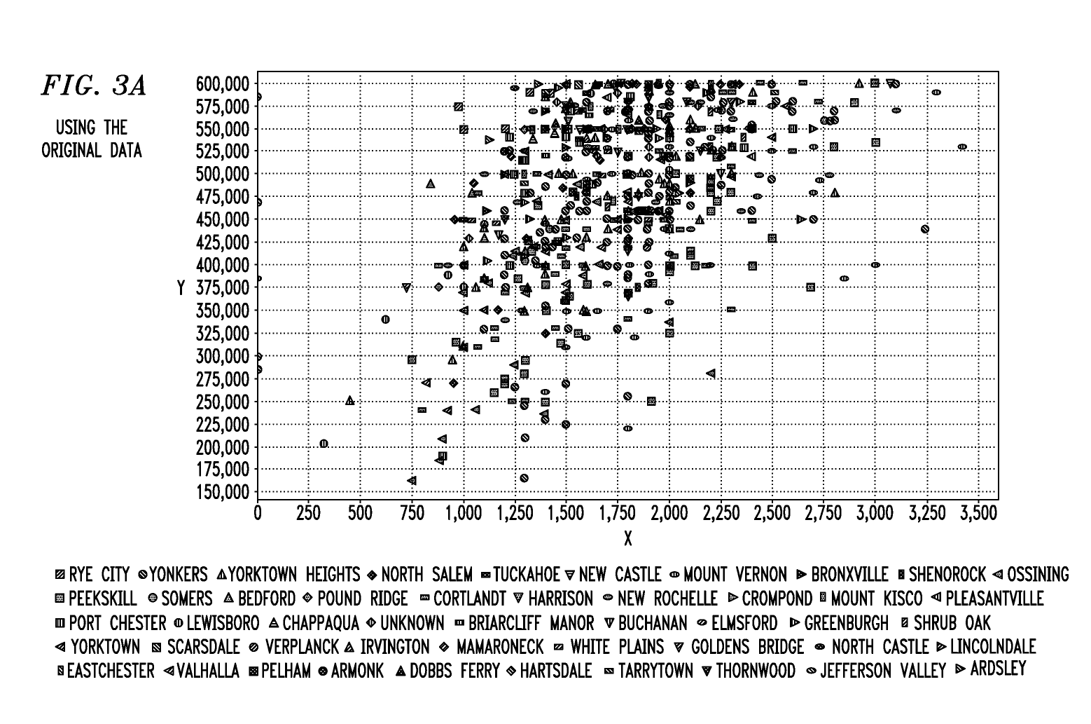

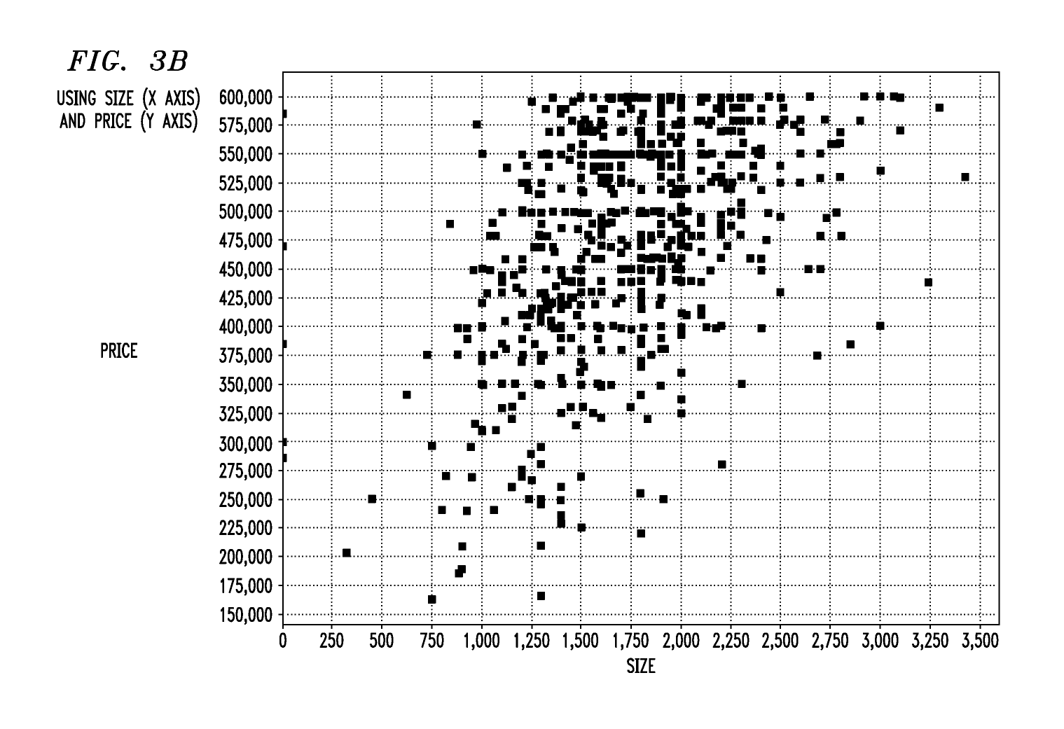

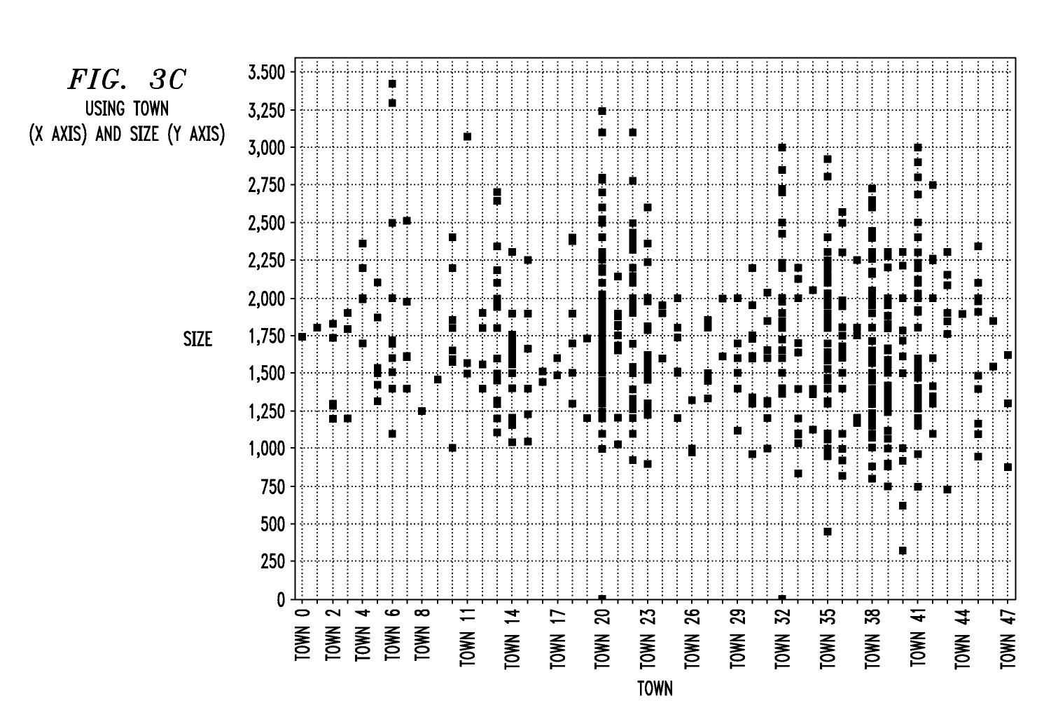

Second, data volume and data complexity affect the quality of a visualization, which in turn impacts a user's information comprehensibility. In particular, large volumes of data often result in much cluttered displays (FIG. 1(b)). In such cases, sampling techniques may be used to reduce the data volume and visual clutter (FIG. 1(c)). Complex data like high dimensional data may also result in complex visualizations. FIG. 3 visualizes the correlation among three data dimensions: house price, size, and the towns where the houses are located. That is, FIG. 3 depicts visual dialog system-generated scatter plots showing correlations of three data dimensions for 650 houses. To produce a more intelligible visualization, principles of the invention provide for dividing the original data (FIG. 3(a)) and creating a series of simpler visualizations (FIGS. 3(b) and 3(c)).

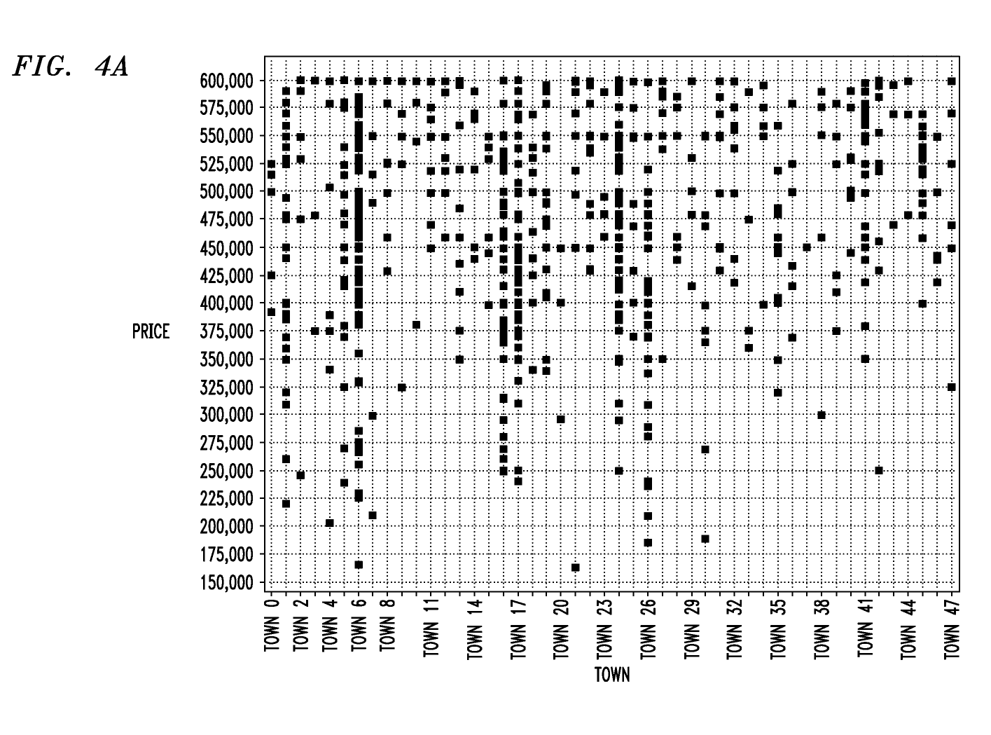

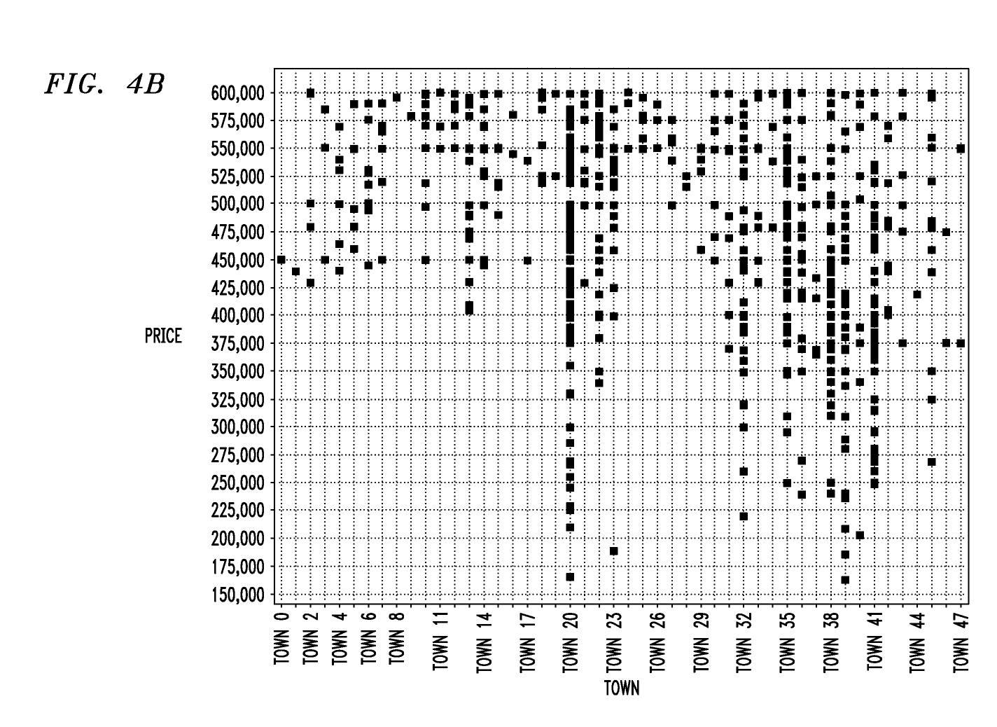

Third, the ability to convey inherent structures of data such as data correlations and clusters improves the effectiveness of a visualization. However, inherent data structures may not always come with the raw data. It is thus often necessary to extract such structures prior to visualization. In FIGS. 4(a) and 4(b), a visual dialog system according to an illustrative embodiment of the invention orders the town names by similar houses so that users can easily perceive different visual clusters (FIG. 4(a) is a scatter plot of the original data, while FIG. 4(b) is a scatter plot of the ordered data).

While different data transformations as described above help to improve the quality of a visualization, an effective visualization must also faithfully convey the intended information. To ensure visual fidelity, a visual dialog system according to principles of the invention chooses data transformations that can best preserve the key properties of the original data. To produce FIG. 1(c), for example, the visual dialog system uses a proper sampling technique to create a less cluttered display while preserving the original house distribution.

In an interactive visual analytic process, users may need to integrate information across consecutive displays. To help users to do so, a visual dialog system according to principles of the invention applies data transformations that are intended to help to maximize visual continuity. For example, when sampling the houses to produce FIG. 1(c), the visual dialog system tries to preserve the houses shown in the previous display to maintain the desired visual continuity.

In summary, visual dialog systems often need to transform the original data for effective visualization. The result of such transformations must meet a wide variety of visualization constraints, including ensuring visual legibility and maintaining visual fidelity. These constraints often exhibit inter-dependencies and may even conflict with one another. For example, ensuring legibility may involving sampling that might violate the visual fidelity constraint. It thus would be very difficult to choose data transformations ad hoc, which may not be able to balance all constraints.

### Optimization-Based Dynamic Data Transformation

To balance all visualization constraints, principles of the invention provide an optimization-based approach to data transformation. Our approach dynamically selects a set of data operators that transforms the original data to optimize the quality of the target visualization. Since the target visualization is yet to be produced, we use data properties captured before and after the transformation to estimate the visualization quality. We explain our approach in three steps. First, we characterize data properties that directly impact visualization quality.

Accordingly, we introduce a set of data operators that can transform these data properties. Second, we formulate a set of visualization quality metrics by the data properties. Since each metric models a visualization constraint (e.g., maximizing visual legibility), we then define an overall objective function to measure the satisfaction of various visualization constraints. Third, we present an algorithm that dynamically derives a set of data operators by maximizing the objective function.

### Visualization Quality-Related Data Characterization

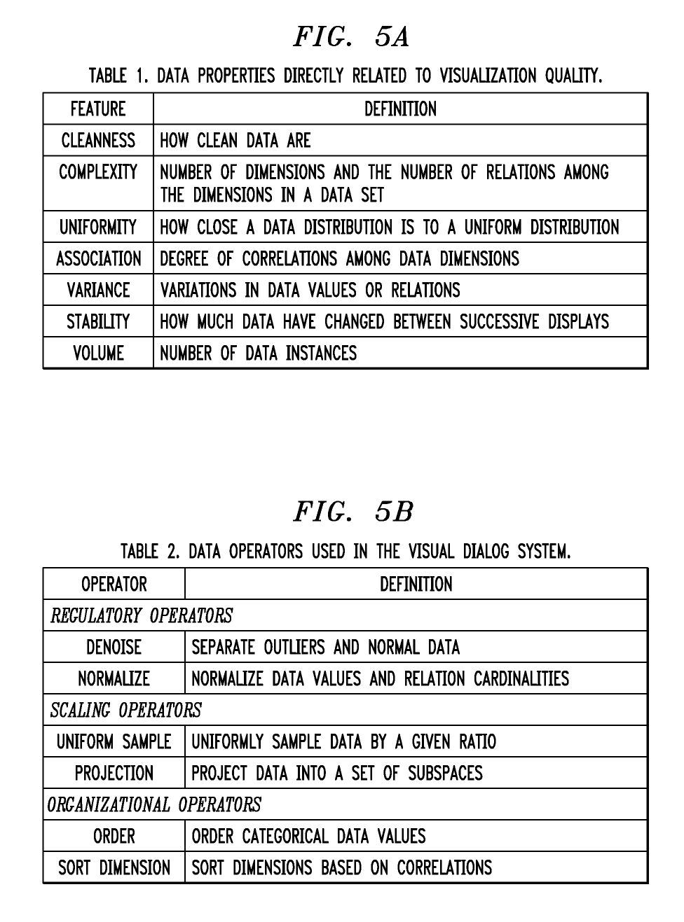

The visual dialog system uses multi-dimensional data tables to represent data to be visualized. Each row in a data table is a data instance; and each column is a data dimension. A data dimension contains either numerical or categorical values. Based on this notion and a wide variety of existing work, we characterize a set of data properties that directly affect visualization quality (Table 1 in FIG. 5(a)). Here we explain five of the complex properties: cleanness, uniformity, association, variance, and stability. The other properties are straightforward.

Data cleanness. Since noisy data directly affect the quality of a visualization, we use data cleanness to measure how noisy a data set is. Here we are mainly concerned with outliers, which may be caused by missing or erroneous data and directly impact visual legibility (FIG. 1a). We use a density-based method to detect outliers. This method computes a local outlier factor (LOF) for each data instance di. The greater the LOF is, the more likely dᵢ is an outlier. Given LOF, the overall cleanness of data set D is then:

cleanness(D)=1−α×Max[LOF(dᵢ),∀i].

Here dᵢ εD, and α is a normalized value indicating the number of outliers in D. By this measure, the data set is less clean if it has more outliers and the outliers are farther out.

Data uniformity. Data distributions also directly influence visualization quality. In particular, a non-uniform data distribution often helps users to discover data patterns. We use data uniformity to assess how close a data distribution is to a uniform distribution. Since a visualization is often created to examine one or more data dimensions, we compute data uniformity along one or more data dimensions. To measure the uniformity of one dimension, we compute its entropy based on information theory. We divide the values of the dimension into N bins, and the uniformity for data dimension d is then defined as:

$$uniformity ( D ) = \frac{- 1}{{E}_{max}} {\sum }_{j} {p}_{j} \times log ( {p}_{j} )$$

Here pⱼ is the probability of a value of the dimension d in the jth bin. Eₘₐₓ is the maximum entropy, the entropy of a uniform distribution. It is used here to normalize the uniformity value.

We use the same formula to measure the overall uniformity of a data set D with multiple data dimensions. In this case, we define a region of D bounded by all the dimensions and divide the region into N sub-regions. Based on this notion, pⱼ in the above formula is then the probability of a data point in the high-dimensional space falling in the jth region.

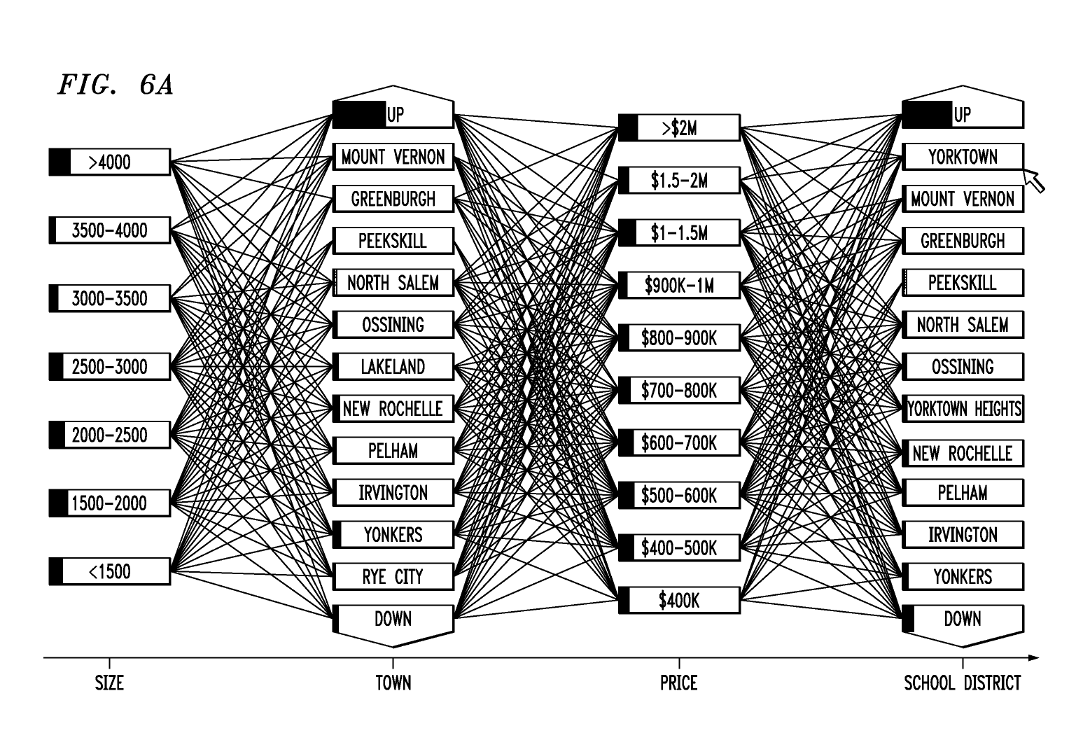

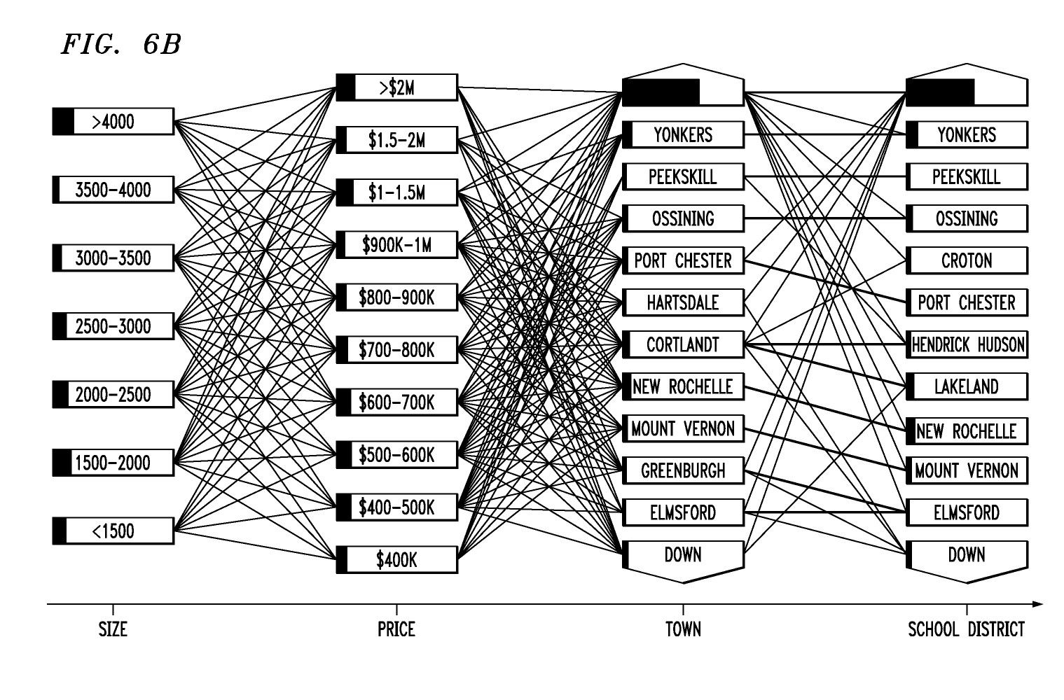

Data association. Generally, it is desirable to visually group highly correlated dimensions together to facilitate information comprehension. For example, dimensions “town” and “school districts” in FIG. 6(a) are highly correlated. When placed next to each other in FIG. 6(b), their correlation becomes visually evident. To capture and reveal such correlations, we compute data association of any two data dimensions. Precisely, the data association of data dimensions dᵢ and dⱼ is:

$$association ( {d}_{i} , {d}_{j} ) = \vert \frac{{\sum }_{k} ( {v}_{k , i} - {\overline{v}}_{i} ) ( {v}_{k , j} - {\overline{v}}_{j} )}{\sqrt{{\sum }_{k} {( {v}_{k , i} - {\overline{v}}_{i} )}^{2} {\sum }_{k} {( {v}_{k , j} - {\overline{v}}_{j} )}^{2}}} \vert$$

This computes the absolute correlation of dᵢ and dⱼ. Here, k=1, . . . , K and K is the maximal number of elements in dᵢ and dⱼ; ν_{k,i} and ν_{k,j} are the values of the kth element in dᵢ and dⱼ, respectively; ν̅ᵢ and ν̅ⱼ are the mean values of dᵢ and dⱼ, respectively. For ordinal values, we use their order indices in the formula. This formula will not be applied to dimensions with nominal values.

Data variance. Variations in data values or relations may also affect visualization quality. In general, largely varied data may render the visualization illegible (FIG. 1d). We use data variance to measure the differences among the data. In particular, we measure two types of differences: value variance and relation variance. Value variance measures the differences among a set of numerical values D^{ν}:

$$variance ( {D}^{v} ) = {\sum }_{i} {( {v}_{i} - \overline{v} )}^{2} ,$$

where νᵢ is the ith value in D^{ν}, and ν̅ is the mean value of D^{ν}.

We use the same formula to measure relation variance. Currently, we address only relations that have varied cardinality. Thus, value νᵢ in above formula is the cardinality for ith relation and ν̅ is the mean cardinality among all the relations. By this notion, we can calculate the port-shipment relation variance in FIG. 1(d). In this case, the cardinality of each port-shipment relation is the number of shipment-delay categories. For example, the cardinality is four if a port has four types of shipment delay.

Data stability. To maintain visual continuity between successive displays, it is often necessary to ensure certain degree of content overlap across displays. We use data stability to measure the data similarity between D, and Dₜ₊, shown in two displays:

stability(Dₜ,Dₜ₊₁)=1−Avg[dist(d_{i,t},d_{i,t+1}),∀i]

Here d_{i,t} and d_{i,t+1} are ith data element at time t and t+1, respectively. Function dist( ) computes the weighted Euclidean distance between two data instances.

### Data Transformation Operators

In the above section, we have characterized a set of data properties that have direct impact on visualization quality. We have also described how to compute these properties for a given data set. Here we present a set of data operators that can transform these properties, which in turn helps to improve the visualization quality. Data operators can be categorized based on their effects. So far we have identified three groups of operators: regulatory operators that clean and normalize data, scaling operators that adjust data volume and complexity, and organizational operators that identify the inherent structures of data and organize the data accordingly.

Table 2 in FIG. 5(b) lists all operators that the visual dialog system currently uses. Table 2 is not intended to be a complete list of data transformation operators. Instead, we address how these operators can shape the data properties to improve the visualization quality. To allow the visual dialog system to handle a wide variety of data transformations systematically, we also introduce a uniform representation of data operators. Moreover, this representation allows us to easily incorporate new operators when needed.

Denoise. Operator Denoise cleans the noisy data by extracting the outliers. Based on the computed local outlier factor (LOF), Denoise determines whether a data instance is an outlier. Specifically, if LOF is greater than a threshold, the instance is then considered noise. The noise will not be included in the target visualization. Instead, the visual dialog system uses a default presentation like a list to convey the outliers (FIG. 1c). As a result, data noises will not impair the comprehension of the target visualization, while users can still be aware of the outliers.

Normalize. Large variations in data affect the legibility of an intended visualization. To amend such situations, Normalize operator is used to reduce data variance, which in turn makes the visualization legible (FIG. 1(f)). Depending on the data semantics, different normalization methods may be used. The visual dialog system chooses a proper normalization method by the following guidelines:
Value normalization by sum is used if the data represents the count information (e.g., the number of shipments);
Relation normalization is used if data relations have varied cardinalities;
If multiple normalization methods are applicable, choose the one that can reduce the data variance the most.

By the above guidelines, the visual dialog system uses the sum of all shipments to normalize the shipment counts for each port in FIG. 1(f). As the result, users now can quickly view and compare the shipment status for all ports, such as the type of the delay and the percentage of shipments in each delay category.

To normalize relations with varied cardinalities, now we use a simple merge-split method. Specifically, we merge similar data into one bin or split one to create multiple bins. For example, the town-house style relation has varied cardinalities since each town may have different numbers of house styles. To normalize the relations, the visual dialog system may merge different styles based on their similarity to form a more general category, e.g., merging raised-ranch and split-ranch to form ranch style. The visual dialog system performs merge/split operations recursively until cardinalities are normalized.

UniformSample. Large volumes of data may cloud a visualization (FIG. 1(b)). Operator UniformSample samples a data set uniformly to reduce its volume. UniformSample always attempts to preserve the original data distribution, which in turn helps to maintain visual fidelity. To ensure visual continuity, the visual dialog system also tries to maximize data stability during sampling. Whenever possible, the UniformSample operator tries to retain data instances that have appeared in the previous display.

Projection. Data complexity may make a visualization difficult to comprehend. Operator Projection divides a complex data space into a set of sub-spaces. As a result, a complex data set can be visualized in a series of simpler visualizations. However, each visualization in the series can present only a partial picture. These partial visualizations must be organized properly so that users can systematically explore and relate them. Similar to projection operations used previously, our Projection operator consists of two steps. First, it divides all data dimensions to be visualized into dimension sets. Each dimension set is then used to produce a partial visualization of the target type. To produce an effective partial visualization, the visual dialog system places dimensions with strong correlations in the same set. All dimension sets are also ordered by the quality of the partial visualization that they can produce. In other words, the most effective partial visualization will be shown to the users first. FIGS. 3(b) and (c) show two partial visualizations created by the visual dialog system using the Projection operator.

Order. A visualization can better help users to discover insights, if it is able to capture the inherent structures of data. Currently, we use operator Order to organize categorical data dimensions (e.g., town names in FIG. 1(d) to help users identify visual clusters. We adopt the clustering approach proposed in to order categorical values in three steps. First, it clusters all data instances (e.g., houses) in a given set using a similarity metric involving all numerical dimensions (e.g., house price and location). Second, it orders the clusters such that the visual pattern recognizability is maximized (see next section). Third, it orders the categorical dimension within each cluster. In case there are multiple categorical dimensions (e.g., house style and town name), we only order the dimension that is mapped onto the X or Y axis.

SortDimension. Data dimensions may be related to one another differently. Capturing and visualizing such relations facilitate users' insight discovery. Specifically, we use Operator SortDimension to order data dimensions so that highly correlated dimensions are visually grouped together. FIG. 6(a) is a parallel coordinate created by the visual dialog system to visualize a set of houses. To improve this visualization, the visual dialog system applies SortDimension to order the four house dimensions based on their correlations. In this case, since town and school are highly correlated, they are now displayed next to each other. As the result, users can easily identify the correlation between the towns and the schools (FIG. 6(b)).

Representing Data Transformation Operators. To represent all operators uniformly, we associate each operator with six features: operand, parameters, metricCompatibility, estimate, apply, and timeCost. Here is the definition of Denoise:

```
Denoise extends Operator {
      Object operand
      List<Float> metricCompatibility
      float threshold
      float estimate( )
      float apply( )
      float timeCost( )
}
```

Here operand denotes the data to be transformed, and parameters hold the specific information that is required to perform the intended transformation. For example, operator Denoise has one parameter threshold, which is used to identify outliers. Feature metricCompatibility holds a list of values assessing how suitable an operator is for improving a visualization quality metric. For example, operator Denoise helps improve visual legibility but reduces visual fidelity. Function estimate( ) predicts the potential improvement of visualization quality after applying the operator. The visual dialog system uses these functions to derive data operators that help improve the quality of the target visualization. Function apply( ) performs the actual data transformation. It returns the computed visualization quality after the transformation. In addition, we use function timeCost to estimate the time needed to perform a transformation. We use a performance profiler to estimate an operator's timeCost, including execution time for both estimate( ) and apply( ).

### Feature-Based Visualization Quality and Cost Metrics

To measure how data transformations affect the quality of a visualization, we quantitatively measure the visualization quality before and after the transformations. Since a visualization has yet to be created at the stage of data transformation, the visual dialog system uses data properties to approximate the visualization quality. We thus focus on only quality metrics that can be measured using data properties. Currently, we have formulated four such metrics: visual legibility, visual pattern recognizability, visual fidelity, and visual continuity. Since each metric models a key visualization constraint, we can then optimize the overall visualization quality by maximizing the satisfaction of all these constraints. Again, our purpose here is not to enumerate a complete list of visualization constraints. Instead, we show how to model these constraints quantitatively using a set of data properties.

Maximizing visual legibility. An effective visualization must be legible. In general, several data properties, including data cleanness and data volume, directly affect legibility. We thus use these data properties to estimate visual legibility (weights λ1=λ2=0.5):

χ(D)=1−(λ₁×complexity(D)+λ₂×density(D)/β) (1)

Here complexity( ) is defined in Table 1. Coefficient β measures how much data a visualization can accommodate. For example, a scatter plot can afford to display more data than a bar chart does. Function density( ) measures the density of the target visualization using three data properties: 1) data cleanness—noisy data like outliers may drive camera out of desired viewing range; 2) data volume—large data sets often cause visual occlusions; and 3) data variance—large variations may render small values unreadable.

density(D)=μ₁×(1−cleanness(D))+μ₂×volume(D)+μ₃×variance(D), where μ₁=μ₂=μ₃=0.33

Maximizing visual pattern recognizability. In addition to maximizing the legibility of visual objects, an effective visualization should assist users in easily detecting visual patterns to gain data insights. There are several ways of maximizing the visual pattern finding capability. First, visualizing non-uniform data distributions helps users detect patterns. Emphasizing data associations also aids users in identifying patterns. In short, users are more likely to recognize visual patterns if the data uniformity is low or there are strong associations among the data dimensions. Therefore, we use data uniformity and data association to estimate visual pattern recognizability:

ξ(D)=ω₁×(1−uniformity(D))+ω₂×association(D) (2)

Ensuring visual fidelity. One of the main concerns in visualization is how to truthfully convey the intended data. Since data transformation alters data properties, if not careful, the interpretation of data may be subverted by the transformation. To ensure that users perceive information as intended by the original data, the visual dialog system attempts to maintain visual fidelity during the data transformation. We adopt a histogram-based measure to assess data faithfulness before and after its transformation:

θ(D)=1−P/MAX_{P} (3)

Here P is the distance between the histograms of the original and transformed data, MAX_{P} is the maximum histogram distance. Histogram distance P is computed as:

$$P = {\sum }_{i} \vert {P}_{o , i} - {P}_{t , i} \vert ,$$

where P_{o,i} is the percentage of original data that fall into the ith bin, and P_{t,i} is the corresponding percentage of the transformed data.

Maintaining visual continuity. Since visual continuity directly affects a user's ability to comprehend information across consecutive displays, the visual dialog system always tries to maximize visual continuity when updating a visualization. Specifically, we maximize the semantic data overlap, a key technique that is used to maximize visual momentum and is also affected most by data transformations. We use data stability to measure the data overlap:

ψ(D₁,Dₜ₊₁)=ε×stability(Dₜ,Dₜ₊₁). (4)

Here stability( ) is the data stability defined in Table 1; ε is a constant representing user intentions that influence visual update. Here ε=1.0 when the user request is a follow up at time t+1. Otherwise, ε=0 when the user starts a new context.

Combining formulas 1-4, we define a metric to measure the overall visualization quality for data set D:

φ(D)=Avg[χ,ξ,θ,ψ]. (5)

We use the same formula to compute the overall visualization quality after applying data transformations Op:

φ(Op,D)=φ(D′)=Avg[χ,ξ,θ,ψ], where D′ is the transformed data. (6)

Transformation cost metric. In addition to maximizing visualization quality, the visual dialog system controls the time cost of transformations. The overall time cost for applying a set of data transformations Op is:

$$τ ( Op ) = \frac{1}{{T}_{max}} \cdot {\sum }_{i} timeCost ( {op}_{i} ) \qquad ( 7 )$$

Here timeCost( ) is the time cost of operator op_{iε}Op, Tₘₐₓ is the allowed maximum execution time.

### Algorithm for Determining Data Transformations

Combining Formulas 6-7, we define an overall objective function:

reward(Op)=w₁×Φ−w₂×τ (8)

Here Op is a set of data operators, and weights w₁=w₂=0.5.

A main goal now is to find a set of data operators that maximizes the objective function. Since some of our metrics are non-linear (e.g., the recognizability metric), our task is to solve a typical nonlinear assignment problem, which is NP-hard. We have developed several algorithms, including simulation annealing, to approximate the optimization. However, estimating the reward of an operator in our case may even be time consuming. To ensure real-time responses, we can only afford to test a limited number of operators. Thus, we developed a greedy algorithm to approximate the optimization process in O(n×m). Here n and m are the total number of data operators and quality metrics, respectively.

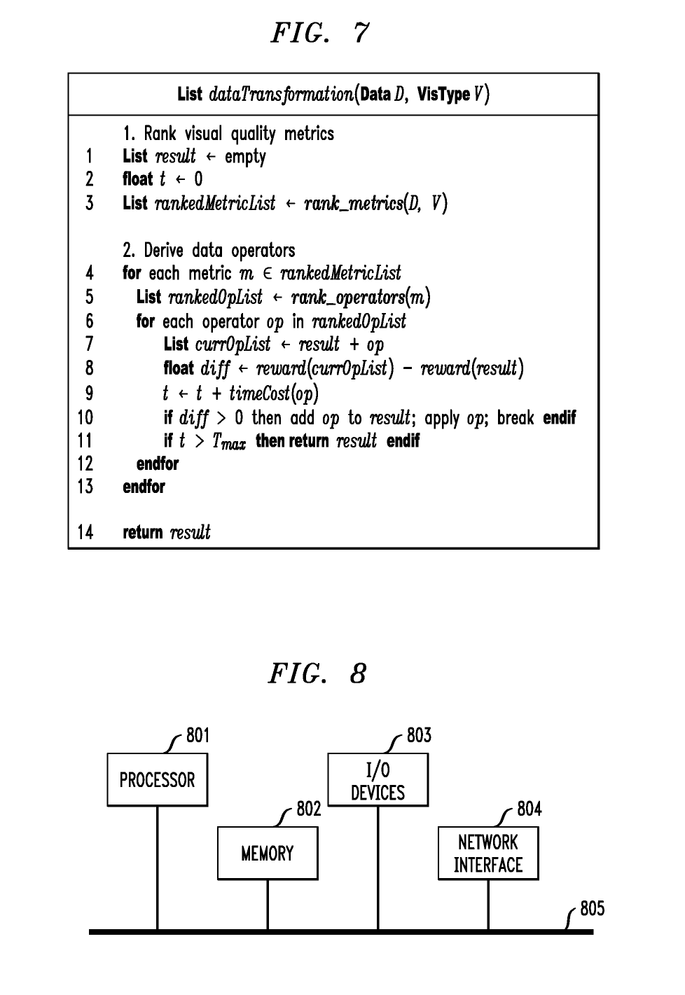

FIG. 7 provides pseudo-code of a data transformation determination algorithm, according to an embodiment of the invention. The input to the algorithm is data D to be visualized and its target visualization type. The visualization type is used to set the coefficient β in the visual legibility metric (Formula 1). The algorithm approximates the optimization in two steps. First, it ranks the values computed by the four visualization quality metrics (Formulas 1-4) such that the worst values are on the top of the list (line 3). In other words, the visual dialog system always attempts to improve the worst visualization quality first. Second, for each quality metric m, the algorithm then uses rank_operators(m) to order data operators by their metricCompatibility (line 5). For each operator op, the algorithm tests whether it is worth applying the transformation (lines 6-10). It first uses Formula 8 to compute the total reward of applying this operator and other already selected operators (lines 7-8). It then compares this reward with that of using only the existing operators (line 10). If the reward is greater, the operator is then added to the result set and the algorithm advances to the next metric (line 10). Otherwise, it proceeds to the next operator in the list for metric m. In this process, the visual dialog system also ensures that the total execution time is within the given time limit Tₘₐₓ. The total time cost is accumulated for testing each operator (line 9). If the accumulated time exceeds Tₘₐₓ, the algorithm returns a list of selected operators (line 12).

### Ensuring Real-Time Responses

In an interactive environment, real-time responses are desired. However, certain data transformations especially when involving large data sets can be time consuming. For example, operators Denoise and Order are computationally intensive for large data sets. We now use two heuristics to ensure real-time responses. First, we define a maximum data volume (MAX_VOLUME) and tune it such that the legibility metric is the first to be addressed (FIG. 7, line 3). As a result, the visual dialog system will use scaling operators first to reduce the data volume before testing other operators. Second, inside each operator, we use approximation to limit the processing time of the estimate( ) function. For example, the visual dialog system calls estimate( ) on a smaller number of grid cells instead of the actual data instances. Specifically, if there are n data items in k-dimensional space, the k-dimensional space can be divided into m (m<<n) grid cells. Then the function estimate( ) uses the center of a cell to approximate the data points in the cell. Using this estimation, the visual dialog system spends less time on testing operators (FIG. 7, line 8).

Referring lastly to FIG. 8, a computer system is illustrated wherein techniques for dynamically determining data transformations in accordance with a visual dialog system may be implemented according to an embodiment of the invention. That is, FIG. 8 illustrates a computer system in accordance with which one or more components/steps of a visual dialog system (e.g., components and methodologies described above in the context of FIGS. 1A through 7) may be implemented, according to an embodiment of the invention. It is to be understood that the individual components/steps may be implemented on one such computer system or on more than one such computer system. In the case of an implementation on a distributed computing system, the individual computer systems and/or devices may be connected via a suitable network, e.g., the Internet or World Wide Web. However, the system may be realized via private or local networks. In any case, the invention is not limited to any particular network.

As shown, the computer system includes processor 801, memory 802, input/output (I/O) devices 803, and network interface 804, coupled via a computer bus 805 or alternate connection arrangement.

It is to be appreciated that the term “processor” as used herein is intended to include any processing device, such as, for example, one that includes a CPU and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. The memory may be considered a computer readable storage medium.

In addition, the phrase “input/output devices” or “I/O devices” as used herein is intended to include, for example, one or more input devices (e.g., keyboard, mouse, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

As described herein, it is realized that, in a highly dynamic environment, data may come in with varied quality and unpredictable characteristics. To prepare the original data for effective visualization, it is highly desirable to dynamically decide the proper data transformations (e.g., data cleaning and scaling). In accordance with inventive principles described herein, we provide an optimization-based approach to data transformation. Given a data set and the specific type of visualization to be created, a main goal is to find a set of data transformations that can help optimize the quality of the target visualization. To achieve this goal, we formulate a set of metrics that use various data properties to estimate the quality of the target visualization, such as visual legibility and visual fidelity. Using these metrics, we then define an objective function that assesses the overall visualization quality to be achieved by data transformations. Finally, we use a greedy algorithm to find a set of data transformations that maximizes the objective function.

Unlike existing work on data transformation, which often focuses on specific transformation techniques in a more deterministic context, our optimization-based approach dynamically balances a wide variety of factors for diverse visualization situations. Our approach is extensible, since we can easily incorporate new data transformation techniques or visualization quality metrics. We have applied our work to two different applications, and our experiments show that the visual dialog system can dynamically apply proper data transformations to significantly improve the visualization quality.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for dynamically deriving data transformations for optimized visualization based on data characteristics and given visualization type, the method comprising the steps of:
obtaining raw data to be visualized and a visualization type to be used; and
dynamically generating a list of data transformation operations that transform the raw input data to produce an optimized visualization for the given visualization type.

2. The method of claim 1, wherein the step of generating a list of data transformation operations further comprises modeling the data transformation operations uniformly using one or more feature-based representations.

3. The method of claim 1, wherein the step of generating a list of data transformation operations further comprises the step of estimating visualization quality using one or more data characteristics.

4. The method of claim 3, wherein the step of estimating visualization quality using one or more data characteristics further comprises the step of modeling visual quality using one or more feature-based desirability metrics.

5. The method of claim 4, wherein the step of modeling visual quality using feature-based desirability metrics further comprises the step of one of the feature-based metrics measuring a visual legibility value.

6. The method of claim 5, wherein the step of one of the feature-based metrics measuring a visual legibility value further comprises the step of measuring a data complexity value.

7. The method of claim 5, wherein the step of one of the feature-based metrics measuring a visual legibility value further comprises the step of measuring a data density value.

8. The method of claim 7, wherein the step of measuring a data density value further comprises the step of measuring a data cleanness value.

9. The method of claim 7, wherein the step of a measuring a data density value further comprises the step of measuring data volume.

10. The method of claim 7, wherein the step of a measuring a data density value further comprises the step of measuring data variance.

11. The method of claim 4, wherein the step of modeling visual quality using one or more feature-based desirability metrics further comprises the step of one of the feature-based metrics measuring a visual pattern recognizability value.

12. The method of claim 11, wherein the step of one of the feature-based metrics measuring a visual pattern recognizability value further comprises the step of measuring a data uniformity value.

13. The method of claim 11, wherein the step of one of the feature-based metrics measuring a visual pattern recognizability value further comprises the step of a measuring data association value.

14. The method of claim 4, wherein the step of modeling visual quality using one or more feature-based desirability metrics further comprises the step of one of the feature-based metrics measuring a visual fidelity value.

15. The method of claim 4, wherein the step of modeling visual quality using one or more feature-based desirability metrics further comprises the step of one of the feature-based metrics measuring a visual continuity value.

16. The method of claim 15, wherein the step of one of the feature-based metrics measuring a visual continuity value further comprises the step of measuring a data stability value.

17. The method of claim 15, wherein the step of one of the feature-based metrics measuring a visual continuity value further comprises the step of using user intentions.

18. The method of claim 1, wherein the step of dynamically generating a list of data transformation operations further comprises the step of estimating a data transformation cost.

19. The method of claim 1, wherein the step of dynamically generating a list of data transformation operations further comprises the step of performing an optimization operation such that one or more desirability metrics are maximized and a transformation cost is limited for one or more data transformation operations.

20. Apparatus for dynamically deriving data transformations for optimized visualization based on data characteristics and given visualization type, the apparatus comprising:
a memory; and
at least one processor coupled to the memory and operative to: (i) obtain raw data to be visualized and a visualization type to be used; and (ii) dynamically generate a list of data transformation operations that transform the raw input data to produce an optimized visualization for the given visualization type.
